(19) United States
(12) Patent Application Publication
(10) Pub. No.: US 2025/0371507 A1
(43) Pub. Date: Dec. 4, 2025

(54) METHOD AND SYSTEM USING LOYALTY COINS AS DIGITAL CURRENCY WITH SMART CONTRACTS

(71) Applicant: Mastercard International Incorporated, Purchase, NY (US)

(72) Inventors: Mrinal MAHAJAN, Bundi (IN); Arnesh MAJHI, Noida (IN); Bharat SHAMNANI, Bhopal (IN); Himanshu NAIK, Gorakhpur (IN); Samta JAIN, New Delhi (IN)

(73) Assignee: Mastercard International Incorporated, Purchase, NY (US)

(21) Appl. No.: 18/676,054

(22) Filed: May 28, 2024

(51) Int. Cl. G06Q 20/06; G06Q 20/36

(52) U.S. Cl. CPC G06Q 20/065; G06Q 20/36; G06Q 2220/00

(57) ABSTRACT

A method for implementing loyalty points as digital currency using blockchain includes: receiving first transaction data for a first transaction including a first recipient address associated with a blockchain wallet and a positive loyalty point amount; processing the received first transaction data for the first transaction to add a first new block to the blockchain that includes the first recipient address and the positive loyalty point amount; receiving, after a predetermined period of time, second transaction data for a second transaction including a second recipient address associated with the blockchain wallet and a negative loyalty point amount; and processing the received second transaction data for the second transaction to add a second new block to the blockchain that includes the second recipient address and the negative loyalty point amount.

### FIELD

The present disclosure relates to implementing loyalty coins as digital currency, specifically the use of a blockchain and smart contracts to implement loyalty points for use in commercial transactions as a digital currency and the provision of a coin exchange platform enabling transfer, trade, purchase and/or sell of loyalty coins.

### BACKGROUND

In every industry, merchants explore all opportunities to separate themselves from competitors to try and win the business of consumers. One mechanism that merchants have used for decades is the loyalty program. Loyalty programs come in many shapes and sizes, but generally all seek to reward a consumer that regularly transacts with the merchant, encouraging the consumer to repeat their business with that merchant rather than go to the merchant's competitors. Loyalty programs vary from more simple systems, such as punch cards that can be used for a specific reward once enough visits to the merchant have been completed, to complex loyalty schemes that have complicated rules for earning points that can be spent in a variety of different ways.

While loyalty programs can be beneficial in enticing a consumer to repeat business with a merchant, there is often significant overhead involved in implementing a loyalty system for a merchant. In addition, loyalty systems that can provide consumer benefits can be difficult for a merchant to quantify for accounting purposes. To help reduce the negative accounting effects, as well as to encourage consumers to use loyalty points or other rewards to further increase engagement, many loyalty systems place expiration dates on the use of loyalty points or earned rewards. However, implementing expiration in a loyalty system adds another layer of complexity and difficulty, which may be not only cost- and resource-prohibitive for implementation by many merchants and other entities but may require additional hardware and/or the download and installation of specific software or firmware.

In addition to such technical difficulties, most loyalty systems are very restrictive in terms of the use of earned loyalty currency and rewards. Loyalty systems often place restrictions on when and how rewards and loyalty points can be used, and, in a vast majority of cases, prohibit the transfer of loyalty points or earned rewards. In many cases, the loyalty systems themselves are incapable of processing the transfer of loyalty currency or rewards, leaving consumers, who are very used to being able to freely transfer currency using a variety of different systems, at a disadvantage and may thus be less inclined to utilize a loyalty system or the merchant that offers the system.

Thus, there is a need for a technological solution for a loyalty system that can be implemented in a manner that is significantly more accessible for both merchants and consumers and that can provide transfer of loyalty currency while maintaining accessibility without requiring a need for the installation of additional/new hardware or the download and installation of specific software or firmware.

### SUMMARY

The present disclosure provides a description of systems and methods for implementing loyalty points as digital currency using blockchain. For example, a blockchain network can operate a blockchain that is used to store point transfers and deductions across blockchain wallets, where each blockchain wallet represents a loyalty program account for a consumer. It may also provide a platform that enables the trade, transfer, purchase and/or sale of loyalty coins between blockchain wallets (e.g., users associated with the blockchain wallets). When loyalty points are earned, a new transaction is added to the blockchain that transfers a positive number of loyalty points to the appropriate blockchain wallet. In some cases, a consumer may wish to return a purchased item to a merchant, from which loyalty points were previously earned. In such instances, a chargeback transaction is initiated, and a negative number of loyalty points would be applied to the appropriate blockchain wallet. In other cases, after a predetermined period of time has passed since the loyalty points were earned, the points expire, resulting in a new transaction added to the blockchain that transfers a negative number of loyalty points to the blockchain wallet. The use of a negative number of points rather than an outgoing transfer from the blockchain wallet enables the system to accurately maintain the number of loyalty points for every consumer with less complication than existing systems and without the need to maintain centralized blockchain wallets for storing loyalty points or to find ways to add new loyalty points into the system if the centralized blockchain wallet balances get too low. Smart contracts can be used to automate the process of point earning as well as tracking the expiration of earned points, negative points earned/calculated as a result of a chargeback transaction, and the transfer, trade, purchase and/or sale of loyalty coins between users/blockchain wallets resulting in a system that operates with minimal interaction by consumers and merchants, can be used across multiple merchants without any modification or extra participation by merchants, and can allow for the transfer of loyalty points across consumers with no merchant involvement, providing a significant number of technological benefits over existing systems.

A method for implementing loyalty points as digital currency using blockchain includes: storing, in a blockchain node of a blockchain network, a blockchain comprised of a plurality of blocks, where each block includes one or more blockchain data entries; receiving, by a receiver of the blockchain node, first transaction data for a first transaction between a first user and a merchant system, the first transaction data including at least a first recipient address associated with a first blockchain wallet, a first transaction amount, and a positive loyalty point amount; processing, by a processor of the blockchain node, the received first transaction data for the first transaction to add a first new block to the blockchain that includes at least a first blockchain data entry corresponding to the first transaction that includes at least the first recipient address and the positive loyalty point amount; receiving, by the receiver of the blockchain node after a predetermined period of time, second transaction data for a second transaction, the second transaction data including at least a second recipient address associated with the blockchain wallet and a negative loyalty point amount; and processing, by the processor of the blockchain node, the received transaction data for the second transaction to add a second new block to the blockchain that includes at least a second blockchain data entry corresponding to the second transaction that includes at least the second recipient address and the negative loyalty point amount.

A system for implementing loyalty points as digital currency using blockchain includes: a blockchain network including a plurality of blockchain nodes; and a blockchain node in the plurality of blockchain nodes including a memory storing a blockchain comprised of a plurality of blocks, where each block includes one or more blockchain data entries, a receiver receiving first transaction data for a first transaction, the first transaction data including at least a first recipient address associated with a blockchain wallet, a first transaction amount, and a positive loyalty point amount, and a processor processing the received first transaction data for the first transaction to add a first new block to the blockchain that includes at least a first blockchain data entry corresponding to the first transaction that includes at least the first recipient address and the positive loyalty point amount, wherein the receiver of the blockchain node further receives, after a predetermined period of time, second transaction data for a second transaction, the second transaction data including at least a second recipient address associated with the blockchain wallet, a second transaction amount, and a negative loyalty point amount, and the processor of the blockchain node processes the received second transaction data for the second transaction to add a second new block to the blockchain that includes at least a second blockchain data entry corresponding to the second transaction that includes at least the second recipient address and the negative loyalty point amount.

A method of using loyalty coins as digital currency with smart contracts includes communicating, by a processor of a processing server, with a plurality of merchant systems and a plurality of user devices; storing, in a memory of the processing server, a plurality of user profiles, each user profile including (i) a user identifier, (ii) a transaction history, and (iii) a total amount of loyalty coins; providing, by the processor of the processing server, a coin exchange platform enabling transfer, trade, purchase and/or sale of loyalty coins based on supply and demand; receiving, by a receiver of the processing server, from a first merchant system of the plurality of merchant systems, a first transaction message associated with a first transaction between a first user and the first merchant system, wherein the first transaction message includes at least a first user identifier, a merchant identifier and a transaction amount; identifying, in the memory of the processing server, a user profile, from the plurality of user profiles, that includes a user identifier that corresponds to the first user identifier included in the first transaction message; calculating, by the processor of the processing server, via execution of a first smart contract, a positive value of loyalty coins associated with the first transaction based on the transaction amount and merchant identifier included in the first transaction message and the transaction history included in the identified user profile; storing, in the memory of the processing server, the positive value of loyalty coins associated with the first transaction as a subset of loyalty coins within the total amount of loyalty coins, wherein the subset is associated with the first merchant system, and wherein the subset of loyalty coins is assigned a predetermined period of time within which subset of loyalty coins are unavailable for transfer, trade and/or sale; receiving, by the receiver of the processing server, a second transaction message associated with a chargeback transaction, wherein the second transaction message includes at least a negative transaction amount and the merchant identifier; calculating, by the processor of the processing server, via execution of a second smart contract, a negative value of loyalty coins associated with the second transaction based on at least the negative transaction amount and the merchant identifier included in the second transaction message; and modifying, by the processing server, the subset of the total amount of loyalty coins on a basis of the calculated negative value of loyalty coins associated with the second transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for implementing loyalty points as digital currency using blockchain in accordance with exemplary embodiments.

FIG. 2 is a block diagram illustrating a blockchain node in the system of FIG. 1 for implementing loyalty points as digital currency using blockchain using blockchain in accordance with exemplary embodiments.

FIG. 3 is a flow diagram illustrating a process for adding loyalty points to a blockchain wallet in the system of FIG. 1 in accordance with exemplary embodiments.

FIG. 4 is a flow diagram illustrating a process for the use of loyalty points from a blockchain wallet in a merchant transaction in the system of FIG. 1 in accordance with exemplary embodiments.

FIG. 5 is a flow diagram illustrating a process for the expiration of loyalty points associated with a blockchain wallet in the system of FIG. 1 in accordance with exemplary embodiments.

FIG. 6 is a flow chart illustrating an exemplary method for implementing loyalty points as digital currency using blockchain in accordance with exemplary embodiments.

FIG. 7 is a flow chart illustrating an exemplary method for implementing loyalty points as digital currency in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Implementing Loyalty Points as Digital Currency

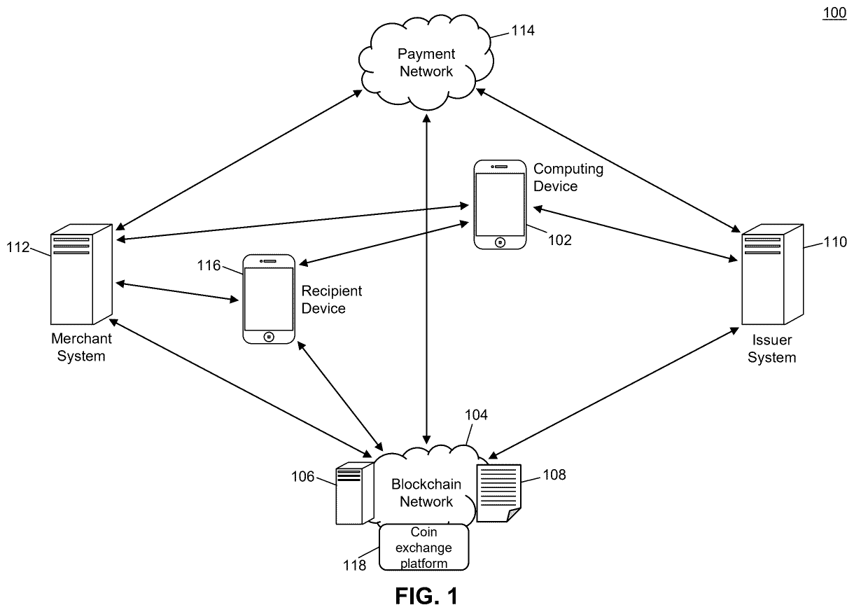

FIG. 1 illustrates a system 100 for the implementation of loyalty points as a digital currency maintained via a blockchain. As used herein, “loyalty points” can refer to points, currency, rewards, or any other value as can be determined by an entity that accepts such value for a benefit. In some cases, if the loyalty points discussed herein are accepted by multiple entities, the value of the loyalty points can vary across each entity, such as where one entity can consider one loyalty point to be worth ten cents while another entity can consider one loyalty point to be worth one dollar.

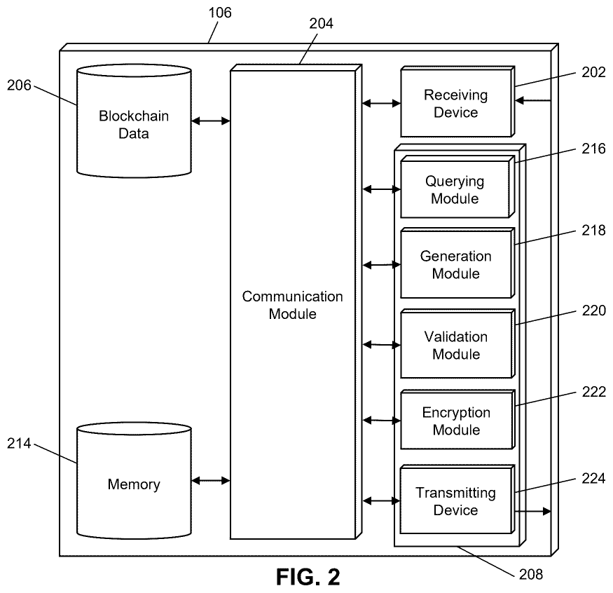

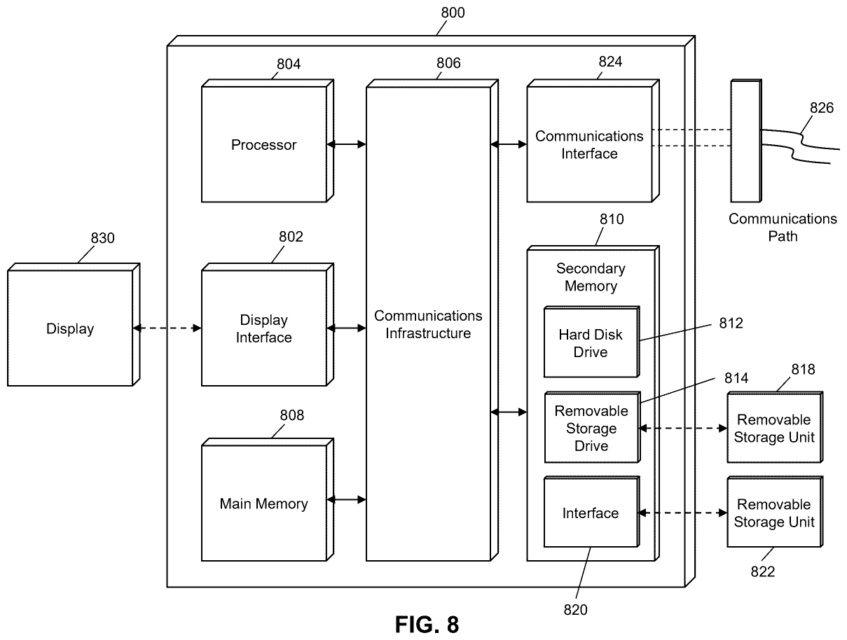

The system 100 can include a computing device 102. The computing device 102 can be a computing system, such as illustrated in FIG. 8 and discussed in more detail below, that can be used by a consumer to store a blockchain wallet for use in receiving, using, transferring, trading, selling and/or purchasing loyalty points, as discussed below. The blockchain wallet can receive, via a blockchain, loyalty points via positive and negative point transfers that are conducted via transactions that are added to the blockchain using the methods discussed herein. The blockchain can be implemented via a blockchain network 104. The blockchain network 104 can be comprised of a plurality of blockchain nodes 106. Each blockchain node 106 can be a computing system, such as illustrated in FIG. 2 or 8, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in a blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104 using the public key of the cryptographic key pair. In some cases, the term “blockchain wallet” can refer specifically to the private key. In other cases, the term “blockchain wallet” can refer to a computing device (e.g., computing device 102) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of currency generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in a blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

The blockchain of the blockchain network 104 can also store smart contracts 108. A smart contract 108 can be a self-executable program that is stored on the blockchain that is configured to self-execute and perform one or more operations when one or more criteria are met. The smart contract can receive input, which can be transferred directly to the smart contract or detected and identified by the smart contract itself, that can be used as part of the execution process of the smart contract. In some cases, a smart contract can be configured to self-execute multiple times to perform the same function multiple times and/or to perform multiple functions one or more times. As discussed in more detail below, the smart contracts 108 stored in the blockchain can be configured to submit new transactions to blockchain nodes 106 to calculate positive and negative values of loyalty points/coins, to transfer positive loyalty point amounts to blockchain wallets, determine when an expiration time for loyalty points has occurred, and transfer an appropriate negative amount of loyalty points to a blockchain wallet to effect the expiration.

In the system 100, a consumer, represented via the computing device 102, can earn loyalty points. In some cases, loyalty points can be specific to a merchant system 112 where the loyalty points can be earned via transactions or other interactions with the merchant system 112 and can only be used in future interactions with the same merchant system 112. In other cases, loyalty points can be earned via other activity performed by the computing device 102. For example, the loyalty points can be tied to a payment instrument, such as a credit card, used by the computing device 102 in payment transactions across one or more merchant systems 112. While such an example is illustrated in FIG. 1 and discussed herein, other methods for earning loyalty points can be utilized in the system 100. In some cases, a user, via the computing device 102, may choose to transfer, trade and/or sell earned loyalty points to another user. In such instances, the blockchain network 104 may provide a coin exchange platform 118 that enables users to transfer, trade, purchase and/or sell earned loyalty points.

The system 100 can include an issuer system 110. The issuer system 110 can be one or more systems that are operated by, on behalf of, or are otherwise associated with an issuer. An issuer can be an entity that establishes (e.g., opens) a letter or line of credit in favor of a beneficiary, and honors drafts drawn by the beneficiary against the amount specified in the letter or line of credit. In many instances, the issuer can be a bank or other financial institution authorized to open lines of credit. In some instances, any entity that can extend a line of credit to a beneficiary may be considered an issuer. The line of credit opened by the issuer can be represented in the form of a payment account and can be drawn on by the beneficiary via the use of a payment card. An issuer can also offer additional types of payment accounts to consumers as will be apparent to persons having skill in the relevant art, such as debit accounts, prepaid accounts, electronic wallet accounts, savings accounts, checking accounts, etc., and can provide consumers with physical or non-physical means for accessing and/or utilizing such an account, such as debit cards, prepaid cards, automated teller machine cards, electronic wallets, checks, etc.

In the system 100, the issuer system 110 can issue a payment card to the computing device 102 (e.g., to the consumer represented by the computing device 102). The computing device 102 can register for a loyalty account with the blockchain network 104 where transactions and other activity using the payment card can earn loyalty points. The computing device 102 can provide the payment account number for the transaction account associated with the payment card to a blockchain node 106 as well as the public key of the cryptographic key pair that comprises the blockchain wallet stored in the computing device 102. The blockchain node 106 can receive the payment account number and public key and store the data in a smart contract 108 that is generated and added to the blockchain.

The smart contract 108 can be configured to monitor for transaction activity for the transaction account associated with the payment card and add loyalty points to the blockchain wallet of the computing device 102 as a result. When the computing device 102 participates in a new payment transaction with a merchant system 112, the payment card can be used to convey payment details to fund the payment transaction using a suitable method, such as via magnetic strip, near field communication, integrated circuit chip, etc. The merchant system 112 can receive the payment details and submit the payment transaction for processing by a payment network 114. In some cases, the payment transaction can be submitted through one or more intermediary systems, such as an acquirer, gateway processor, etc. and can be received by the payment network 114 as an authorization request.

The payment network 114 can be a system or network used for the transfer of money via the use of cash-substitutes for thousands, millions, and even billions of transactions during a given period. Payment networks can use a variety of different protocols and procedures in order to process the transfer of money for various types of transactions. Transactions that can be performed via a payment network can include product or service purchases, credit purchases, debit transactions, fund transfers, account withdrawals, etc. Payment networks can be configured to perform transactions via cash-substitutes, which can include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein can refer to both the payment network as an entity, and the physical payment network, such as the equipment, hardware, and software comprising the payment network, which can also be referred to as “payment rails.”

The payment network 114 can receive, from the merchant system 112, an authorization request for the payment transaction, which can be a data message that is specially formatted pursuant to one or more standards governing the exchange of financial transaction messages, such as the International Organization of Standardization's ISO 8583 or ISO 20022 standards. The authorization request can include a plurality of data elements, where each data element is stores a data value as set forth in the applicable standard, including a message type indicator indicative of an authorization request for a new submitted payment transaction that requires processing. The payment network 114 can route the authorization request to the issuer system 110, which can be identified by a bank identification number or other value in the payment account number stored in the payment details included in the authorization request. The issuer system 110 can then approve the payment transaction (e.g., if the transaction account associated with the payment account number has sufficient credit or balance to cover the transaction amount) and return an authorization response to the payment network 114 via the payment rails thereof that indicates approval of the payment transaction. The authorization response can be routed to the merchant system 112 by the payment network 114, which can cause the merchant system 112 to provide the transacted-for goods or services to the computing device 102 in exchange for the payment made via the successfully processed payment transaction.

The smart contract 108 can be configured to monitor for such transaction activity. In some embodiments, the smart contract 108 can receive transaction data for payment transactions using suitable push or pull methods directly from issuer systems 110, from merchant systems 112, from payment networks 114, or from other suitable data sources. For instance, in one example, following registration by the computing device 102, the blockchain node 106 can establish communication with the issuer system 110 and request transaction data for all future payment transactions involving the transaction account associated with the payment account number provided by the computing device 102 during registration. In such an example, after approval of the above payment transaction by the issuer system 110, the issuer system 110 can submit transaction data for the payment transaction as input to the smart contract 108.

The smart contract 108 can receive transaction data for one or more payment transactions and, using the transaction data, determine that loyalty points have been earned and calculate the appropriate value of loyalty points. The earning of loyalty points can be calculated on a basis of transaction amounts, merchant categories, merchant identifiers, transaction history, transaction frequency, product categories, geographic location, and any other transaction data and/or a combination thereof. For instance, in one example, a computing device 102 can earn one loyalty point per dollar spent on all transactions. In another example, a computing device 102 can earn loyalty points per spending on transactions across multiple merchant categories (e.g., two points per dollar for groceries, three points per dollar from travel, and one point per dollar for all other transactions). In yet another example, loyalty points can be limited to a specific maximum amount earned during a given period of time (e.g., a maximum of one hundred points per day and/or two thousand points per month). In another example, loyalty points can be earned and/or affected by the time and/or date of a transaction (e.g., extra loyalty points for transactions on Sundays) or geographic location (e.g., loyalty points can only be earned in the country of record for the transaction account). Such rules regarding the earning of loyalty points can be stored in the smart contract 108 itself. In some cases, the rules can vary from one smart contract 108 to another, such as for different reward levels provided to different consumers or different loyalty systems provided by different issuer systems 110.

The smart contract 108 can analyze the received transaction data and, using the rules stored in the smart contract 108, determine that the computing device 102 has earned loyalty points. Upon determining that the computing device 102 has earned loyalty points, the smart contract 108 calculates the appropriate value (e.g., a positive amount) and can generate a new blockchain transaction for the transfer of the positive amount of earned loyalty points to the blockchain wallet of the computing device 102. The smart contract 108 can use the public key of the blockchain wallet of the computing device 102 provided during registration to generate a blockchain address associated with the blockchain wallet. The new blockchain transaction can include the blockchain address as well as the positive amount of loyalty points, where the amount of loyalty points can be calculated by the smart contract 108 according to the received transaction data and applicable rules. In some embodiments, the smart contract 108 can digitally sign the new blockchain transaction or provide other attestation that can be verified by a blockchain node 106 to ensure that the new blockchain transaction is being submitted by an authorized party, which is, in this case, the smart contract 108. The smart contract 108 can submit the new blockchain transaction to a blockchain node 106 in the blockchain network 104 using a suitable method.

The blockchain node 106 can receive the new blockchain transaction and perform any necessary validations (e.g., of a digital signature using a public key of a cryptographic key pair associated with the smart contract 108). The blockchain node 106 can then generate a new blockchain data entry for the new blockchain transaction that includes the destination address and positive amount of loyalty points, which can be included in a new block generated by the blockchain node 106. The new block can then be transmitted to a plurality of other blockchain nodes 106 in the blockchain network 104 for confirmation and addition to the blockchain using suitable methods and systems.

The result of the addition of the new blockchain data entry to the blockchain is that the blockchain wallet associated with the computing device 102 has received the earned loyalty points as a result of their transaction activity. The computing device 102 can, upon request of a user of the computing device 102, display an available balance of loyalty points based on activity involving the blockchain wallet as can be read from the blockchain by the computing device 102. When the computing device 102 is interested in using the loyalty points, the computing device 102 can provide a loyalty number or other identifying value to the merchant system 112 along with the payment details when participating in a new payment transaction. In some cases, the computing device 102 can provide the destination address(es) for the loyalty points to be used as well as a digital signature generated using the private key of the cryptographic key pair that comprises the blockchain wallet of the computing device 102, such that the amount and ownership of the loyalty points can be verified. The loyalty number or other identifying value, destination address(es), digital signature, and any other data used in the redemption of loyalty points is collectively referred to herein as “loyalty data.”

The merchant system 112 can receive the loyalty data along with the payment details, if necessary, for the payment transaction from the computing device 102 using a suitable communication network and method. The merchant system 112 can verify the available balance of loyalty points and ownership thereof by the computing device 102. In some cases, the merchant system 112 can verify the available balance and ownership itself, such as by verifying the digital signature using the public key of the computing device 102 and analyzing blockchain data of the blockchain to determine the amount of loyalty points transferred to the destination address(es) and that no other subsequent transactions using those loyalty points occurred. In other cases, the merchant system 112 can provide the loyalty data to a blockchain node 106 or other system, which can perform the verification and provide a result of the verification to the merchant system 112 using a suitable communication network and method. If the verification is unsuccessful, the merchant system 112 can indicate accordingly to the computing device 102, where the computing device 102 can remedy any issues with the loyalty data or proceed with the transaction without redeeming loyalty points.

If the verification is successful, the merchant system 112 can proceed with the payment transaction and perform any actions necessary as a result of the redemption of loyalty points. For instance, in one example, the transaction amount for the payment transaction can be reduced based on the amount of loyalty points redeemed. In another example, the computing device 102 can be provided with additional goods and/or services following successful processing of the payment transaction. In yet another example, the merchant system 112 can provide the transacted-for goods or services to the computing device 102 without requiring any payment (or any processed payment transaction) if sufficient loyalty points are used.

Once the loyalty points have been accepted by the merchant system 112 for redemption, the merchant system 112 can electronically transmit a redemption message to the smart contract 108, such as direct transmission to an address of the smart contract 108 or via transmission to a blockchain node 106 that can identify the appropriate smart contract 108 and submit the redemption message as input thereto. The redemption message can include the amount of loyalty points that were redeemed. In some cases, the redemption message can also include the destination address(es) and/or digital signature provided by the computing device 102 in the loyalty data. The smart contract can generate a new blockchain transaction that deducts the spent loyalty points from the blockchain wallet using a suitable method. In one instance, a new blockchain transaction can have a negative amount of loyalty points corresponding to the spent loyalty points added to a new destination address generated using the public key of the blockchain wallet of the computing device 102. In other instance, the new blockchain transaction can transfer the spent amount of loyalty points from the destination address(es) of the blockchain wallet of the computing device 102 to an inactive blockchain wallet or null address, with any remainder transferred to a new destination address of the blockchain wallet of the computing device 102 for use in future transactions. The smart contract 108 can submit the new blockchain transaction to a blockchain node 106, which can have the new blockchain transaction added to the blockchain using the methods discussed above.

In some embodiments, earned loyalty points can expire if unused during a predetermined period of time. In such embodiments, smart contracts 108 can be configured to monitor for when the predetermined period of time has passed since earned loyalty points were transferred to the computing device 102. The predetermined period of time can be stored in the smart contract 108, such as in the rules regarding earning loyalty points. In some cases, the predetermined period of time can vary based on how the loyalty points were earned. In such cases, when determining which loyalty points, if any, were spent, the smart contract 108 can prioritize the spending of loyalty points with earlier expiration times to maximize the available of loyalty points for a computing device 102.

When the smart contract 108 determines that the predetermined period of time has elapsed since loyalty points were earned, the smart contract 108 can identify all transaction activity on the blockchain involving the blockchain wallet of the computing device 102 to determine if any of the loyalty points due for expiring were spent. If all of the loyalty points were spent, the smart contract 108 may take no additional action. If some or all of the loyalty points were unspent, the smart contract 108 can generate a new blockchain transaction to deduct the loyalty points from the blockchain wallet. The new blockchain transaction can include a destination address for the blockchain wallet of the computing device 102, generated using the public key of the cryptographic key pair of the blockchain wallet, as well as a negative amount of loyalty points, where the negative amount of loyalty points is based on the amount of unspent loyalty points set for expiration. The new blockchain transaction may also include a transaction amount associated with the unspent loyalty points. In some instances, the smart contract 108 can calculate the negative amount of loyalty points based on the transaction amount, the merchant identifier of the merchant system 112 from which the loyalty points were earned, the amount of time since the transaction between the user and the merchant system, etc. The smart contract 108 can submit the new blockchain transaction to a blockchain node 106, which can have the new blockchain transaction added to the blockchain using the methods discussed above. The negative amount of loyalty points will then be considered by the computing device 102 when determining available balance of loyalty points for use and by merchant systems 112 or other entities when verifying the availability of loyalty points for use in future transactions by the computing device 102.

In some embodiments, computing device 102 may transfer unspent loyalty points to other blockchain wallets using a coin exchange platform 118 provided by the blockchain network 104. In such an embodiment, the system 100 can include a recipient device 116. The recipient device 116 can be a computing device (e.g., like the computing device 102) associated with a different consumer that includes a blockchain wallet for participation in the loyalty system by the other consumer. The recipient device 116 can provide a destination address to the computing device 102, generated using the public key of the cryptographic key pair of the blockchain wallet of the recipient device 116, using a suitable communication network and method. The computing device 102 can generate a new blockchain transaction for transfer of a specific positive amount of loyalty points to the destination address provided by the recipient device 116, along with any other information necessary for the transfer (e.g., unspent transaction outputs, digital signatures, etc.) and submit the new blockchain transaction to a blockchain node 106 using a suitable communication network and method. The blockchain node 106 can process the new blockchain transaction using traditional methods and systems to transfer the specified amount of loyalty points to the recipient device's blockchain wallet. The recipient device 116 can then use the loyalty points in future transactions using the methods discussed above.

In some embodiments, after the computing device 102 earns a certain amount of loyalty points (e.g., positive value of loyalty points) as a result of a transaction with merchant system 112, that positive value of loyalty points is assigned a preset time period within which they are not available for transfer, trade and/or sale on the coin exchange platform. Thus, during the preset time period, a user is only permitted to redeem the those earned loyalty points at the merchant system 112. After the preset time period has elapsed, the earned loyalty points become available for transfer, trade or sale in addition to redemption. A coin/points exchange transaction may then be initiated, via the coin exchange platform 118, from the blockchain wallet of the computing device 102 to the destination address of the recipient device 116 (e.g., blockchain wallet associated with the recipient device 116).

In cases where loyalty points that are determined to have expired by the smart contract 108 have transferred, the smart contract 108 can transmit a notification to a smart contract associated with the blockchain wallet of the recipient device 116 indicating that the transferred points have expired. The smart contract associated with the blockchain wallet of the recipient device 116 can then perform the necessary actions related to expiration of loyalty points as discussed above. In some instances, the smart contract 108 for the computing device 102 can detect or be notified when loyalty points are transferred by the computing device 102. In such instances, the smart contract 108 for the computing device 102 can notify the smart contract associated with the blockchain wallet of the recipient device 116 of the expiration date of the transferred loyalty points, which can then be tracked by the smart contract associated with the blockchain wallet of the recipient device 116 for passage of the predetermined period of time. In some cases, the smart contract associated with the blockchain wallet of the recipient device 116 can detect when the blockchain wallet of the recipient device 116 has been transferred loyalty points from another blockchain wallet due to use of destination address generated using the public key of the blockchain wallet of the recipient device 116. In such cases, the smart contract can determine when the transferred loyalty points were earned on the blockchain and can determine the predetermined period of time for expiration of the transferred loyalty points based thereon.

The methods and systems discussed herein provide for the implementation of loyalty points as digital currency using blockchain. The use of a blockchain provides for a publicly accessible, decentralized storage mechanism or loyalty points that is merchant-agnostic, issuer-agnostic, and can allow for the free transfer of loyalty points across consumers. This results in a system that has significant technical advantages over existing loyalty programs that can provide significant benefits to both consumers and merchants while requiring significantly less interaction and maintenance by consumers and merchants. In addition, the use of negative transaction amounts in blockchain transactions can provide for an implementation via blockchain that requires less overhead and maintenance than traditional blockchain transaction systems.

### Blockchain Node

FIG. 2 illustrates an embodiment of a blockchain node 104. It will be apparent to persons having skill in the relevant art that the embodiment of the blockchain node 104 illustrated in FIG. 2 is provided as illustration only and cannot be exhaustive to all possible configurations of the blockchain node 104 suitable for performing the functions as discussed herein. For example, the computer system 800 illustrated in FIG. 8 and discussed in more detail below can be a suitable configuration of the blockchain node 104.

The blockchain node 104 can include a receiving device 202 (e.g., receiver). The receiving device may be a circuit that accepts signals from a wireless or wired transmission medium and subsequently decodes or translates the signals into a form configured to drive local circuits. The receiving device 202 can be configured to receive data over one or more networks via one or more network protocols. In some instances, the receiving device 202 can be configured to receive data from computing devices 102, other blockchain nodes 106, issuer systems 110, merchant systems 112, payment networks 114, recipient devices 116, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by computing devices 102 and/or recipient devices 116 that can be superimposed or otherwise encoded with registration data including public keys and payment card numbers, new blockchain transactions, blockchain data requests, digital signatures, destination addresses, transaction amounts, etc. The receiving device 202 can be configured to receive data signals electronically transmitted by other blockchain nodes 106, which can be superimposed or otherwise encoded with public keys, configuration keys, configuration key requests, request for identification data, blockchain data entries, blocks, confirmation messages, etc. The receiving device 202 can also be configured to receive data signals electronically transmitted by issuer system 110, merchant systems 112, and/or payment networks 114 that can be superimposed or otherwise encoded with transaction data for processed payment transactions. The receiving device 202 can also be configured to receive data signals electronically transmitted by merchant systems 112, which can be superimposed or otherwise encoded with new blockchain transactions, destination addresses, spent loyalty points amounts, etc.

The blockchain node 104 can also include a communication module 204. The communication module 204 can be configured to transmit data between modules, engines, databases, memories, and other components of the blockchain node 104 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the blockchain node 104 and external components of the blockchain node 104, such as externally connected databases, display devices, input devices, etc.

The blockchain node 104 can also include a processing device 208 (e.g., central processing unit (CPU). The processing device 208 can be configured to perform the functions of the blockchain node 104 discussed herein as will be apparent to persons having skill in the relevant art. In some embodiments, the processing device 208 can include and/or be comprised of a plurality of engines and/or modules specially configured to perform one or more functions of the processing device, such as a querying module 216, generation module 218, validation module 220, encryption module 222, etc. As used herein, the term “module” can be software or hardware particularly programmed to receive an input, perform one or more processes using the input, and provides an output. The input, output, and processes performed by various modules will be apparent to one skilled in the art based upon the present disclosure.

The blockchain node 104 can also include blockchain data 206, which can be stored in a memory 214 of the blockchain node 104 or stored in a separate area within the blockchain node 104 or accessible thereby. The blockchain data 206 can include a blockchain, which may be comprised of a plurality of blocks and be associated with the blockchain network 104 and a blockchain. In some cases, the blockchain data 206 can further include any other data associated with the blockchain and management and performance thereof, such as block generation algorithms, digital signature generation and confirmation algorithms, communication data for blockchain nodes 106, cryptographic keys, etc. The blockchain data 206 can also include one or more smart contracts 108 stored in the blockchain, where one smart contract 108 can be stored that is associated with each registered computing device 102. In some cases, a single smart contract 108 can be used for performing the functions discussed herein with respect to a plurality of computing devices 102.

The blockchain node 104 can also include a memory 214. The memory 214 can be configured to store data for use by the blockchain node 104 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the blockchain node 104 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, user profiles, device profiles, device profile data, configuration keys, cryptographic keys including public keys and/or private keys, communication data, blockchain algorithms and data, encryption algorithms, etc.

The blockchain node 104 can include a querying module 216. The querying module 216 can be configured to execute queries on databases to identify information. The querying module 216 can receive one or more data values or query strings and can execute a query string based thereon on an indicated database, such as the blockchain data 206 of the blockchain node 104 to identify information stored therein. The querying module 216 can then output the identified information to an appropriate engine or module of the blockchain node 104 as necessary. The querying module 216 can, for example, execute a query on the blockchain data 206 to identify a smart contract 108 to which received transaction data is to be submitted as input.

The blockchain node 104 can also include a generation module 218. The generation module 218 can be configured to generate data for use by the blockchain node 104 in performing the functions discussed herein. The generation module 218 can receive instructions as input, can generate data based on the instructions, and can output the generated data to one or more modules of the blockchain node 104. For example, the generation module 218 can be configured to generate blockchain data entries, blocks, encryption keys, device profiles, request messages, configuration keys, smart contracts 108, etc.

The blockchain node 104 can also include a validation module 220. The validation module 220 can be configured to perform data validations and verifications for the blockchain node 104 as part of the functions discussed herein. The validation module 220 can receive instructions as input, can perform data validations or verification as instructed, and can output a result of the data validations or verifications to one or more modules of the blockchain node 104. In some cases, the input can include the data to be validated or verified and/or data to be used in the validation or verification. In other cases, the validation module 220 can be configured to identify such data, such as in the blockchain data 206 and/or memory 214. The validation module 220 can be configured to, for example, validate new blockchain data entries and/or blocks, verify digital signatures, validate device profile data, verify successful encryptions, verify configuration key or cryptographic key authenticity, etc.

The blockchain node 104 can also include an encryption module 222. The encryption module 222 can be configured to encrypt and/or decrypt data for the blockchain node 104 as part of the functions discussed herein. The encryption module 222 can receive instructions as input, can encrypt or decrypt data as instructed, and can output a result of the encryption or decryption to one or more modules of the blockchain node 104. In some cases, the input can include the data to be encrypted or decrypted and/or keys for use in the encryption or decryption. In other cases, the encryption module 222 can be configured to identify such data, such as in the memory 214.

The blockchain node 104 can also include a transmitting device 224 (e.g., transmitter—an electronic telecommunications device configured to transmit data). The transmitting device 224 can be configured to transmit data over one or more networks via one or more network protocols. In some instances, the transmitting device 224 can be configured to transmit data to computing devices 102, other blockchain nodes 106, issuer systems 110, merchant systems 112, payment networks 114, recipient devices 116, and other entities via one or more communication methods, local area networks, wireless area networks, cellular communication, Bluetooth, radio frequency, the Internet, etc. In some embodiments, the transmitting device 224 can be comprised of multiple devices, such as different transmitting devices for transmitting data over different networks, such as a first transmitting device for transmitting data over a local area network and a second transmitting device for transmitting data via the Internet. The transmitting device 224 can electronically transmit data signals that have data superimposed that can be parsed by a receiving computing device. In some instances, the transmitting device 224 can include one or more modules for superimposing, encoding, or otherwise formatting data into data signals suitable for transmission.

The transmitting device 224 can be configured to electronically transmit data signals to computing devices 102 and/or recipient devices 116 that are superimposed or otherwise encoded with notification messages regarding earned, spent, transferred, traded, sold, purchased or expired loyalty points, requests for registration data, requests for transaction data, etc. The transmitting device 224 can also be configured to electronically transmit data signals to other blockchain nodes 106, which can be superimposed or otherwise encoded with converted device profiles, public key requests, configuration keys, configuration key requests, identification data for computing devices 102 and recipient devices 116, blockchain data entries, blocks, confirmation messages, etc. The transmitting device 224 can also be configured to electronically transmit data signals to issuer systems 110, merchant systems 112, and payment networks 114 that are superimposed or otherwise encoded with requests for transaction data, which can include payment card numbers, blockchain addresses, loyalty numbers, etc.

### Process for Transfer of Earned Loyalty Points

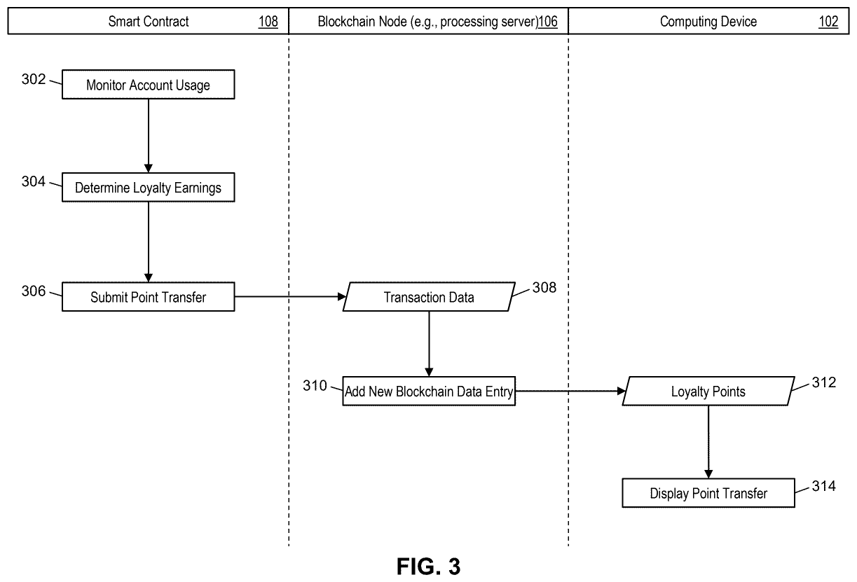

FIG. 3 illustrates a process in the system 100 of FIG. 1 for the automated detection of earned loyalty points via smart contract 108 on a blockchain as a result of transaction data.

In step 302, the smart contract 108 can monitor for transaction activity for a transaction account associated with a payment card registered by the computing device 102 during a registration process with the blockchain network 104. Once transaction activity is detected, the smart contract 108 can receive transaction data for the payment transaction(s) between a user (e.g., computing device 102) and a merchant system 112 and, in step 304, can determine a positive loyalty point amount that is earned (i.e., how many loyalty points are earned) for the blockchain wallet of the computing device 102 as a result of the transaction activity. The loyalty points earned can be based on the transaction data for the payment transaction(s), transaction history between the user and the merchant system 112, as well as any applicable rules and/or algorithms that can be stored in the smart contract 108. In step 306, the smart contract 108 can generate a new blockchain transaction that includes a destination address for the blockchain wallet of the computing device 102 (e.g., generated via the public key of the blockchain wallet) and a positive amount of loyalty points as determined in step 304. The smart contract 108 can submit the new blockchain transaction for transfer of points to a blockchain node 106 in the blockchain network 104 using a suitable communication network and method.

In step 308, the receiving device 202 of the blockchain node 106 can receive the new blockchain transaction. In step 310, the blockchain node 106 can generate a new block that includes a new blockchain data entry for the new blockchain transaction, which can be added to the blockchain using a suitable process (e.g., distribution to and confirmation by a plurality of other blockchain nodes 106 in the blockchain network 104). Once the new blockchain data entry is added to the blockchain, the computing device 102 can, in step 312, detect that loyalty points have been earned by the blockchain wallet as a result of the transfer of loyalty points to a destination address for the blockchain wallet. In some instances, the smart contract 108 and/or blockchain node 106 can generate a notification of the earned loyalty points with the destination address that can be transmitted directly to the computing device 102 using a suitable communication network and method. In step 314, the computing device 102 can display a notification message to the user thereof to notify the user that the earned loyalty points have been transferred to the blockchain wallet for use in future transactions. In cases where the loyalty points can expire, the notification message can indicate the time and/or date of expiration for the earned loyalty points.

### Process for Spending Earned Loyalty Points

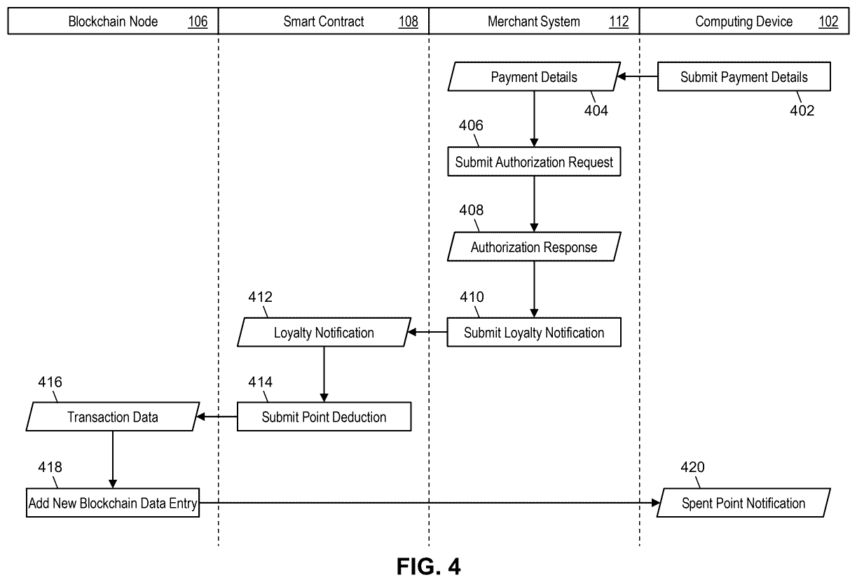

FIG. 4 illustrates a process in the system 100 of FIG. 1 for the spending of loyalty points from a blockchain wallet in a payment transaction with a merchant system 112.

In step 402, the computing device 102 can electronically transmit payment details to the merchant system 112 for use in an electronic payment transaction. The payment details can include both data related to the payment method to fund the electronic payment transaction as well as loyalty data. The data related to the payment method can include a payment card number, expiration date, security code, zip code, and any other data for use in identifying and authenticating the transaction account used to fund the electronic payment transaction. The loyalty data can include a loyalty number or other identifying data, such as the public key of the cryptographic key pair of the blockchain wallet of the computing device 102, destination addresses, digital signatures, and any other data as discussed herein. The data can be transmitted to the merchant system 112 using any suitable communication network and method, such as via near field communication, an application program, a form on a webpage, etc.

In step 404, the merchant system 112 can receive the payment details from the computing device 102. In step 406, the merchant system 112 can generate and submit an authorization request for the electronic payment transaction to the payment network 114. The authorization request can include the data related to the payment method and other transaction data for the electronic payment transaction, such as a transaction amount, transaction time and/or date, geographic location, merchant identifier, merchant category code, product data, etc. The payment network 114 can process the electronic payment transaction using suitable methods and return an authorization response indicating approval of the electronic payment transaction to be received, in step 408, by the merchant system 112. The merchant system 112 can identify that the transaction was approved and successfully processed and, in step 410, can generate and submit a loyalty notification message to the smart contract 108.

The loyalty notification message can include the loyalty data received from the computing device 102 as well as the amount of loyalty points spent. In step 412, the smart contract 108 can receive the loyalty notification message from the merchant system 112. In step 414, the smart contract 108 can generate a new blockchain transaction for deduction of the spent loyalty points from the blockchain wallet of the computing device 102, which can be submitted to a blockchain node 106 in the blockchain network 104. The new blockchain transaction can include a negative amount of the spent loyalty points as well as the loyalty number or other identifying data, destination addresses, digital signatures, etc. In step 416, the receiving device 202 of the blockchain node 106 can receive the new blockchain transaction from the smart contract 108. In step 418, the blockchain node 106 can generate a new block that includes a new blockchain data entry for the new blockchain transaction, which can be added to the blockchain using a suitable process (e.g., distribution to and confirmation by a plurality of other blockchain nodes 106 in the blockchain network 104).

Once the new blockchain data entry is added to the blockchain, the computing device 102 can, in step 420, detect that loyalty points have been spent by the blockchain wallet as a result of the electronic payment transaction. In some instances, the smart contract 108 and/or blockchain node 106 can generate a notification of the spent loyalty points that can be transmitted directly to the computing device 102 using a suitable communication network and method.

### Process for Expiration of Earned Loyalty Points

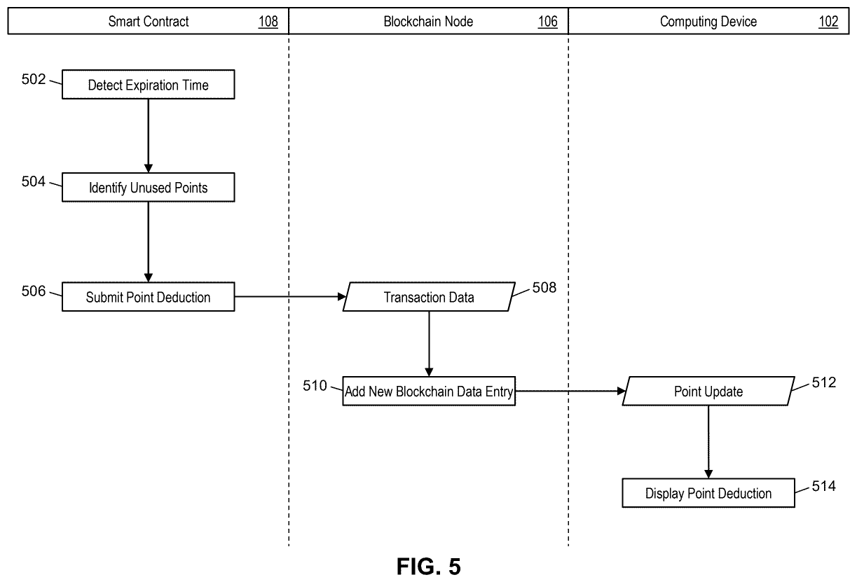

FIG. 5 illustrates a process in the system 100 of FIG. 1 for the expiration of unspent loyalty points in a blockchain wallet after a predetermined expiration period has passed via operation by a smart contract 108.

In step 502, the smart contract 108 can determine that a predetermined period of time has elapsed since loyalty points were earned by the blockchain wallet of the computing device 102, indicating that the points, if unspent, have expired. In step 504, the smart contract 108 can identify if any of the loyalty points due for expiration are unspent. The smart contract 108 can analyze blockchain transactions involving the blockchain wallet of the computing device 102 to identify any negative amounts of loyalty points subsequent to earning the loyalty points and determine if any of the earned loyalty points remain unspent. In cases where expiration periods can differ for earned loyalty points, the smart contract 108 can determine unspent loyalty points in a manner that minimizes the amount of loyalty points that expire for the computing device 102.

In step 506, the smart contract 108 can generate a new blockchain transaction that includes a destination address for the blockchain wallet of the computing device 102 (e.g., generated via the public key of the blockchain wallet) and a negative amount of loyalty points that correspond to the unspent loyalty points that are due for expiration as determined in step 504. The smart contract 108 can submit the new blockchain transaction for deduction of loyalty points to a blockchain node 106 in the blockchain network 104 using a suitable communication network and method. In step 508, the receiving device 202 of the blockchain node 106 can receive the new blockchain transaction. In step 510, the blockchain node 106 can generate a new block that includes a new blockchain data entry for the new blockchain transaction, which can be added to the blockchain using a suitable process (e.g., distribution to and confirmation by a plurality of other blockchain nodes 106 in the blockchain network 104). Once the new blockchain data entry is added to the blockchain, the computing device 102 can, in step 512, detect that loyalty points have expired as a result of the transfer of a negative amount of loyalty points to a destination address for the blockchain wallet. In some instances, the smart contract 108 and/or blockchain node 106 can generate a notification of the expired loyalty points with the destination address that can be transmitted directly to the computing device 102 using a suitable communication network and method. In step 514, the computing device 102 can display a notification message to the user thereof to notify the user that the indicated amount of loyalty points have expired.

### First Exemplary Method for Implementing Loyalty Points as Digital Currency

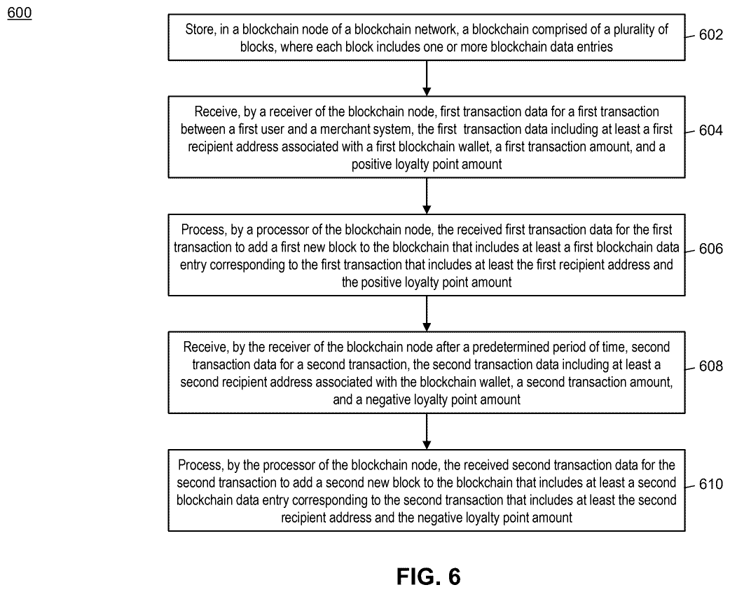

FIG. 6 illustrates an exemplary method 600 for the implementation of loyalty points as a digital currency managed via a blockchain.

In step 602, a blockchain comprised of a plurality of blocks can be stored (e.g., as blockchain data 206) in a blockchain node (e.g., blockchain node 106) in a blockchain network (e.g., blockchain network 104), where each block includes one or more blockchain data entries. In step 604, first transaction data for a first transaction between a first user (e.g., of computing device 102) and a merchant system 112 can be received by a receiver (e.g., receiving device 202) of the blockchain node (e.g., blockchain node 106), the first transaction data including at least a first recipient address associated with a first blockchain wallet (e.g., computing device 102), a first transaction amount, and a positive loyalty point amount. In step 606, a processor (e.g., processing device 208) of the blockchain node (e.g., blockchain node 106) can process the received first transaction data for the first transaction to add a first new block to the blockchain that includes at least a first blockchain data entry corresponding to the first transaction that includes at least the first recipient address and the positive loyalty point amount. In some embodiments, the processor calculates, via execution of a smart contract 108, the positive loyalty point amount on a basis of at least the first transaction amount, a merchant identifier associated with the merchant system 112 and a transaction history associated with the first user (e.g., between the first user and the merchant system 112).

In step 608, the receiver (e.g., receiving device 202) of the blockchain node (blockchain node 106) can receive, after a predetermined period of time, second transaction data for a second transaction, the second transaction data including at least a second recipient address associated with the blockchain wallet and a negative loyalty point amount. In step 610, the processor (e.g., processing device 208) of the blockchain node (e.g., blockchain node 106) can process the received second transaction data for the second transaction to add a second new block to the blockchain that includes at least a second blockchain data entry corresponding to the second transaction that includes at least the second recipient address and the negative loyalty point amount. In some embodiments, the processor calculates, via execution of the smart contract 108, the negative loyalty point amount on a basis of at least a second transaction amount and the merchant identifier.

In one embodiment, the negative loyalty point amount can be equivalent to the positive loyalty point amount. In a further embodiment, the negative loyalty point amount can be equivalent to the positive loyalty point amount subtracted by a spending point amount for any subsequent transactions involving the blockchain wallet. In some embodiments, the predetermined period of time can be based on time elapsed since receiving the transaction data for the first transaction.

In one embodiment, a block of the plurality of blocks comprising the blockchain can include the smart contract (e.g., smart contract 108). In a further embodiment, the first transaction data for the first transaction can be received from the smart contract 108. In another further embodiment, the second transaction data for the second transaction can be received from the smart contract 108. In an even further embodiment, the smart contract 108 can be configured to automatically self-execute after the predetermined period of time.

### Second Exemplary Method for Implementing Loyalty Points as Digital Currency

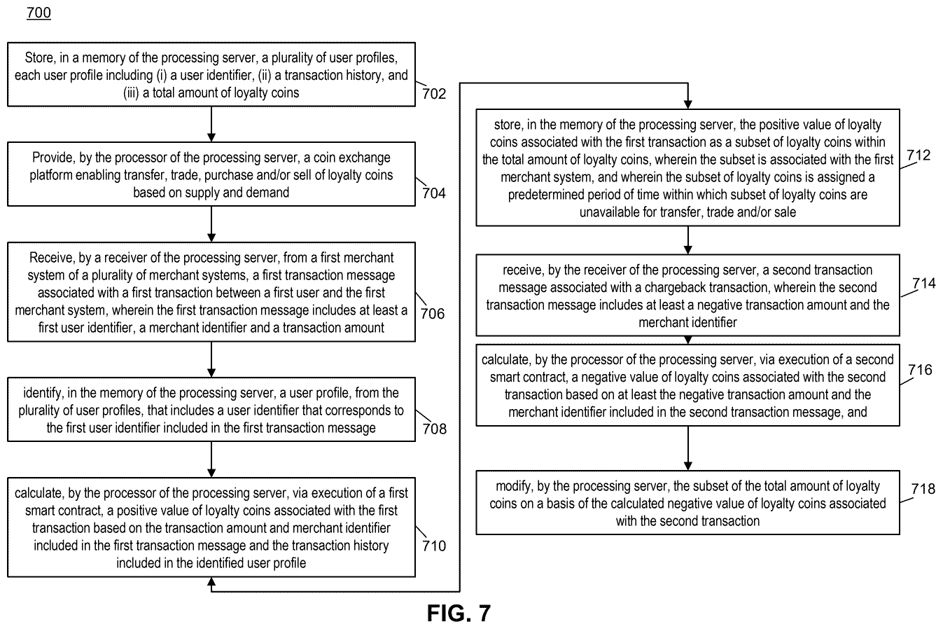

FIG. 7 illustrates an exemplary method 700 for the implementation of loyalty points as a digital currency.

In step 702, a memory of a processing server stores a plurality of user profiles, each user profile including (i) a user identifier, (ii) a transaction history, and (iii) a total amount of loyalty coins. In some embodiments, the processing server is a blockchain node (e.g., blockchain node 106 in FIG. 2) in a blockchain network 104. In step 704, a processor (e.g., processor 208) of the processing server provides a coin exchange platform enabling transfer, trade, purchase and/or sell of loyalty coins based on supply and demand. In step 706, a receiver (e.g., receiving device 202) receives, from a first merchant system (e.g., merchant system 112) of a plurality of merchant systems, a first transaction message associated with a first transaction between a first user (e.g., of computing device 102) and the first merchant system (e.g., merchant system 112) for the purchase of, for example, an item. The first transaction message includes at least a first user identifier, a merchant identifier associated with the first merchant system (e.g., merchant system 112) and a transaction amount associated with the first transaction. In step 708, a user profile, from the plurality of user profiles, is then identified in the memory (e.g., memory 214) of the processing server. The user profile includes a user identifier that corresponds to the first user identifier included in the first transaction message received from the first merchant system (e.g., merchant system 112).

In step 710, the processor (e.g., processing device 208) of the processing server calculates, via execution of a first smart contract, a positive value of loyalty coins associated with the first transaction based on the transaction amount and merchant identifier included in the first transaction message and the transaction history included in the identified user profile. In step 712, the positive value of loyalty coins associated with the first transaction is stored, in the memory (e.g., memory 214) of the processing server, as a subset of loyalty coins within the total amount of loyalty coins, wherein the subset is associated with the first merchant system (e.g., merchant system 112), and wherein the subset of loyalty coins is assigned a preset time period within which the subset of loyalty coins is unavailable for transfer, trade and/or sale.

In step 714, the receiver (e.g., receiving device 202) of the processing server receives a second transaction message associated with a chargeback transaction, where the second transaction message includes at least a negative transaction amount and the merchant identifier. For example, the user may wish to return the purchased item (from which the positive value of loyalty coins was earned). In step 716, the processor (e.g., processing device 208) of the processing server calculates, via execution of a second smart contract, a negative value of loyalty coins associated with the second transaction (e.g., chargeback transaction) based on at least the negative transaction amount and the merchant identifier included in the second transaction message. In step 718, the processing server modifies the subset of the total amount of loyalty coins on a basis of the calculated negative value of loyalty coins associated with the second transaction.

In some embodiments, the first user (e.g., computing device 102) may wish to transfer loyalty coins after the preset time period has elapsed. The first user may access the coin exchange platform 118 provided by the processing server (e.g., within blockchain network 104). The user may access the coin exchange platform 118 via a webpage, or an application downloaded and installed onto the computing device 102. On a basis of user input, the coin exchange platform 118 may then initiate a transfer, trade or sale of a value of loyalty coins in the subset of loyalty coins from a first blockchain wallet associated with the first user to a second blockchain wallet associated with a second user.

In some embodiments, the processing server (e.g., blockchain node 106) may process the received first transaction data for the first transaction to add a first new block to a blockchain that includes at least a first blockchain data entry corresponding to the first transaction that includes at least a first recipient address (e.g., first blockchain wallet) and the positive value of loyalty coins.

In some embodiments, the processing server (e.g., blockchain node 106) may process the received second transaction data for the second transaction to add a second new block to the blockchain that includes at least a second blockchain data entry corresponding to the second transaction that includes at least a second recipient address and the negative value of loyalty coins.

### Computer System Architecture

FIG. 8 illustrates a computer system 800 in which embodiments of the present disclosure, or portions thereof, can be implemented as computer-readable code. For example, the computing device 102, blockchain node 106, issuer system 110, merchant system 112, and recipient device 116 can be implemented in the computer system 800 using hardware, non-transitory computer readable media having instructions stored thereon, or a combination thereof and can be implemented in one or more computer systems or other processing systems. Hardware can embody modules and components used to implement the methods of FIGS. 3-7.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 804 can be a special purpose or a general purpose processor device specifically configured to perform the functions discussed herein. The processor device 804 can be connected to a communications infrastructure 806, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 can also include a main memory 808 (e.g., random access memory, read-only memory, etc.), and can also include a secondary memory 810. The secondary memory 810 can include the hard disk drive 812 and a removable storage drive 814, such as a floppy disk drive, a magnetic tape drive, an optical disk drive, a flash memory, etc.

The removable storage drive 814 can read from and/or write to the removable storage unit 818 in a well-known manner. The removable storage unit 818 can include a removable storage media that can be read by and written to by the removable storage drive 814. For example, if the removable storage drive 814 is a floppy disk drive or universal serial bus port, the removable storage unit 818 can be a floppy disk or portable flash drive, respectively. In one embodiment, the removable storage unit 818 can be non-transitory computer readable recording media.

In some embodiments, the secondary memory 810 can include alternative means for allowing computer programs or other instructions to be loaded into the computer system 800, for example, the removable storage unit 822 and an interface 820. Examples of such means can include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 800 can also include a communications interface 824. The communications interface 824 can be configured to allow software and data to be transferred between the computer system 800 and external devices. Exemplary communications interfaces 824 can include a modem, a network interface (e.g., an Ethernet card), a communications port, a PCMCIA slot and card, etc. Software and data transferred via the communications interface 824 can be in the form of signals, which can be electronic, electromagnetic, optical, or other signals as will be apparent to persons having skill in the relevant art. The signals can travel via a communications path 826, which can be configured to carry the signals and can be implemented using wire, cable, fiber optics, a phone line, a cellular phone link, a radio frequency link, etc.

The computer system 800 can further include a display interface 802. The display interface 802 can be configured to allow data to be transferred between the computer system 800 and external display 830. Exemplary display interfaces 802 can include high-definition multimedia interface (HDMI), digital visual interface (DVI), video graphics array (VGA), etc. The display 830 can be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 808 and secondary memory 810, which can be memory semiconductors (e.g., DRAMs, etc.). These computer program products can be means for providing software to the computer system 800. Computer programs (e.g., computer control logic) can be stored in the main memory 808 and/or the secondary memory 810. Computer programs can also be received via the communications interface 824. Such computer programs, when executed, can enable computer system 800 to implement the present methods as discussed herein. In particular, the computer programs, when executed, can enable processor device 804 to implement the methods illustrated by FIGS. 3-7, as discussed herein. Accordingly, such computer programs can represent controllers of the computer system 800. Where the present disclosure is implemented using software, the software can be stored in a computer program product and loaded into the computer system 800 using the removable storage drive 814, interface 820, and hard disk drive 812, or communications interface 824.

The processor device 804 can comprise one or more modules or engines configured to perform the functions of the computer system 800. Each of the modules or engines can be implemented using hardware and, in some instances, can also utilize software, such as corresponding to program code and/or programs stored in the main memory 808 or secondary memory 810. In such instances, program code can be compiled by the processor device 804 (e.g., by a compiling module or engine) prior to execution by the hardware of the computer system 800. For example, the program code can be source code written in a programming language that is translated into a lower level language, such as assembly language or machine code, for execution by the processor device 804 and/or any additional hardware components of the computer system 800. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for implementing loyalty points as digital currency using blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for implementing loyalty points as digital currency using blockchain, comprising:
storing, in a blockchain node of a blockchain network, a blockchain comprised of a plurality of blocks, where each block includes one or more blockchain data entries;
receiving, by a receiver of the blockchain node, first transaction data for a first transaction between a first user and a merchant system, the first transaction data including at least a first recipient address associated with a first blockchain wallet, a first transaction amount, and a positive loyalty point amount;
processing, by a processor of the blockchain node, the received first transaction data for the first transaction to add a first new block to the blockchain that includes at least a first blockchain data entry corresponding to the first transaction that includes at least the first recipient address and the positive loyalty point amount;
receiving, by the receiver of the blockchain node after a predetermined period of time, second transaction data for a second transaction, the second transaction data including at least a second recipient address associated with the blockchain wallet, a second transaction amount and a negative loyalty point amount; and
processing, by the processor of the blockchain node, the received second transaction data for the second transaction to add a second new block to the blockchain that includes at least a second blockchain data entry corresponding to the second transaction that includes at least the second recipient address and the negative loyalty point amount.

2. The method of claim 1, wherein the negative loyalty point amount is equivalent to the positive loyalty point amount subtracted by a spending point amount for any subsequent transactions involving the blockchain wallet.

3. The method of claim 1, wherein a block of the plurality of blocks comprising the blockchain includes a smart contract.

4. The method of claim 1, further comprising:
calculating, by a processing device of a processing server, via execution of a smart contract, the positive loyalty point amount based on the first transaction amount, a merchant identifier associated with the first merchant system and a transaction history associated with the first user.

5. The method of claim 1, wherein the processing server is a blockchain node in the blockchain network.

6. The method of claim 3, wherein the first transaction data for the first transaction and the second transaction data for the second transaction are received from the smart contract.

7. The method of claim 3, wherein the smart contract is configured to automatically self-execute after the predetermined period of time.

8. The method of claim 1, wherein the predetermined period of time is based on time elapsed since receiving the transaction data for the first transaction.

9. The method of claim 1, further comprising:
calculating, by a processing device of a processing server, via execution of a smart contract, the negative loyalty point amount based on at least the second transaction amount and the merchant identifier included in the second transaction data.

10. The method of claim 1, further comprising: providing a coin exchange platform enabling transfer, trade, purchase and/or sell of loyalty coins based on supply and demand.

11. A system for implementing loyalty points as digital currency using blockchain, comprising:
a blockchain network including a plurality of blockchain nodes; and
a blockchain node in the plurality of blockchain nodes including
a memory storing a blockchain comprised of a plurality of blocks, where each block includes one or more blockchain data entries,
a receiver receiving first transaction data for a first transaction between a first user and a merchant system, the first transaction data including at least a first recipient address associated with a first blockchain wallet, a first transaction amount, and a positive loyalty point amount, and
a processor processing the received first transaction data for the first transaction to add a first new block to the blockchain that includes at least a first blockchain data entry corresponding to the first transaction that includes at least the first recipient address and the positive loyalty point amount, wherein
the receiver of the blockchain node further receives, after a predetermined period of time, second transaction data for a second transaction, the second transaction data including at least a second recipient address associated with the blockchain wallet, a second transaction amount and a negative loyalty point amount, and
the processor of the blockchain node processes the received second transaction data for the second transaction to add a second new block to the blockchain that includes at least a second blockchain data entry corresponding to the second transaction that includes at least the second recipient address and the negative loyalty point amount.

12. The system of claim 11, wherein the negative loyalty point amount is equivalent to the positive loyalty point amount subtracted by a spending point amount for any subsequent transactions involving the blockchain wallet.

13. The system of claim 11, wherein the system further comprises:
a processing server including a processing device, said processing device configured to calculate, via execution of a smart contract, the positive loyalty point amount based on the first transaction amount, a merchant identifier associated with the first merchant system and a transaction history associated with the first user.

14. The system of claim 11, wherein a block of the plurality of blocks comprising the blockchain includes a smart contract.

15. The system of claim 13, wherein the processing server is a blockchain node in the blockchain network.

16. The system of claim 11, wherein the first transaction data for the first transaction and the second transaction data for the second transaction are received from the smart contract.

17. The system of claim 14, wherein the smart contract is configured to automatically self-execute after the predetermined period of time.

18. The system of claim 11, wherein the predetermined period of time is based on time elapsed since receiving the transaction data for the first transaction.

19. A method of using loyalty coins as digital currency with smart contracts, the method comprising:
storing, in a memory of a processing server, a plurality of user profiles, each user profile including (i) a user identifier, (ii) a transaction history, and (iii) a total amount of loyalty coins;
providing, by a processor of the processing server, a coin exchange platform enabling transfer, trade, purchase and/or sell of loyalty coins based on supply and demand;
receiving, by a receiver of the processing server, from a first merchant system of a plurality of merchant systems, a first transaction message associated with a first transaction between a first user and the first merchant system, wherein the first transaction message includes at least a first user identifier, a merchant identifier and a transaction amount; identifying, in the memory of the processing server, a user profile, from the plurality of user profiles, that includes a user identifier that corresponds to the first user identifier included in the first transaction message;
calculating, by the processor of the processing server, via execution of a first smart contract, a positive value of loyalty coins associated with the first transaction based on the transaction amount and merchant identifier included in the first transaction message and the transaction history included in the identified user profile;
storing, in the memory of the processing server, the positive value of loyalty coins associated with the first transaction as a subset of loyalty coins within the total amount of loyalty coins, wherein the subset is associated with the first merchant system, and wherein the subset of loyalty coins is assigned a preset time period within which the subset of loyalty coins is unavailable for transfer, trade and/or sale;
receiving, by the receiver of the processing server, a second transaction message associated with a chargeback transaction, wherein the second transaction message includes at least a negative transaction amount and the merchant identifier;
calculating, by the processor of the processing server, via execution of a second smart contract, a negative value of loyalty coins associated with the second transaction based on at least the negative transaction amount and the merchant identifier included in the second transaction message; and
modifying, by the processing server, the subset of the total amount of loyalty coins on a basis of the calculated negative value of loyalty coins associated with the second transaction.

20. The method of claim 19, further comprising:
initiating, by the coin exchange platform, after the preset time period has elapsed, a transfer, trade or sale of a value of loyalty coins in the subset of loyalty coins from a first blockchain wallet associated with the first user to a second blockchain wallet associated with a second user.

21. The method of claim 19, wherein the processing server is a blockchain node of a blockchain network.

22. The method of claim 21, further comprising:
processing the received first transaction data for the first transaction to add a first new block to a blockchain that includes at least a first blockchain data entry corresponding to the first transaction that includes at least a first recipient address and the positive value of loyalty coins; and
processing the received second transaction data for the second transaction to add a second new block to the blockchain that includes at least a second blockchain data entry corresponding to the second transaction that includes at least a second recipient address and the negative value of loyalty coins.
